(19) United States
(12) Patent Application Publication
(10) Pub. No.: US 2008/0239407 A1
(43) Pub. Date: Oct. 2, 2008

(54) FACSIMILE SYSTEM

(75) Inventor: Shohei Tsujimoto, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/054,290

(22) Filed: Mar. 24, 2008

(30) Foreign Application Priority Data
Mar. 30, 2007 (JP) 2007090105

(51) Int. Cl. H04N 1/00

(52) U.S. Cl. 358/407

(57) ABSTRACT

A facsimile system having a facsimile server, an administrative terminal, a sender facsimile machine, and receiver facsimile machines is provided. The sender facsimile machine includes a sender-side transmitter unit to transmit facsimile usable data and first information to the facsimile server. The administrative terminal includes a terminal-side data storage to store second information and location information, an input unit, a terminal-side receiver unit, a search unit to search for the second information corresponding to the first information, and a terminal-side transmitter unit to transmit the location information to the facsimile server. The facsimile server includes a server-side receiver unit to receive the facsimile usable data and the first information, a server-side data storage, and a server-side transmitter unit to transmit the first information to the administrative terminal and the facsimile usable data to the receiver facsimile machine.

### CROSS REFERENCE TO RELATED APPLICATION

This application claims priority from Japanese Patent Application NO. 2007-090105, filed on Mar. 30, 2007, the entire subject matter of which is incorporated herein by reference.

### BACKGROUND

1. Technical Field

An aspect of the present invention relates to a facsimile system including a transmitter facsimile machine, a facsimile server, and a receiver facsimile machine.

2. Related Art

Today, facsimile machines to transmit and receive images are widely used. Meanwhile, e-mail transmission, in which information can be transmitted to a specifically designated individual, has been widely spread. In Japanese Patent Provisional Publication No. H3-289756, a technique to combine these communication methods is disclosed. In this technique, facsimile usable data is converted into e-mail usable data to be transmitted so that the designated recipient can receive the data in the e-mail format. In this configuration, in order to maintain confidentiality of contents of the transmitted data, the recipient may be required to input a password for authentication upon receiving the e-mail data so that the transmitted e-mail data can be received specifically by the designated individual.

### SUMMARY

In the above configuration, however, such data conversion into the e-mail usable data can cause additional processes, which may not be desirable. In some cases, the facsimile usable data is desired to be transmitted rather in the unconverted facsimile usable format, because, for example, in that way the designated individual can obtain the information in a ready-printed format on a sheet of paper.

Yet, in facsimile transmission, in which the information is printed on a sheet of paper when the data is received, the information can be easily exposed to unintended individuals, therefore, confidentiality of the information may not be protected. For example, when some information is intended to be received by a specific individual who is staying in a hotel room, facsimile usable data representing the information can be transmitted to a facsimile machine equipped in the room. However, if the intended individual has checked out the hotel before the transmission, the information on the sheet of paper can be exposed to unintended individuals who enter the room thereafter.

In view of the above, the present invention is advantageous in that a facsimile system having facsimile machines, which are capable of transmitting facsimile usable data to an intended recipient securely, is provided.

According to an aspect of the invention, there is provided a facsimile system having a facsimile server, an administrative terminal, which is connected with the facsimile server, a sender facsimile machine, which is connected with the facsimile server through a first network, and a plurality of receiver facsimile machines, which are connected with the facsimile server through a second network. The sender facsimile machine includes a sender-side transmitter unit, which transmits facsimile usable data and first information indicating an intended recipient of the facsimile usable data to the facsimile server. The administrative terminal includes a terminal-side data storage, which stores second information, indicating a user of one of the receiver facsimile machines, and location information, indicating a location of the one of the receiver facsimile machines, the second information and the location information being associated with each other in the terminal-side data storage, an input unit, which is operated to store and remove the second information in and from the terminal-side data storage, a terminal-side receiver unit to receive the first information transmitted from the sender-side transmitter via the facsimile server, a search unit to search the terminal-side data storage to detect the second information, which corresponds to the first information being received by the terminal-side receiver unit, and a terminal-side transmitter unit to transmit the location information, which is associated with the second information, to the facsimile server when the second information is detected by the search unit. The facsimile server includes a server-side receiver unit to receive the facsimile usable data and the first information transmitted from the sender-side transmitter unit, a server-side data storage to store the facsimile usable data transmitted from the sender-side transmitter unit for a predetermined time period, a server-side transmitter unit to transmit the first information, transmitted from the sender-side transmitter unit, to the administrative terminal and the facsimile usable data to the one of the receiver facsimile machines, which is indicated by the location information, when the location information transmitted from the terminal-side transmitter unit is received by the server-side receiver unit.

According to another aspect of the invention, there is provided a method to deliver facsimile usable data transmitted from a sender facsimile machine to a predetermined receiver facsimile machine through a first network and a second network according to recipient information, which indicates an intended recipient of the facsimile usable data and is associated with the facsimile usable data. The method includes storing user information, which indicates a user of the predetermined receiver facsimile machine, to be associated with location information, which indicates a location of the predetermined receiver facsimile machine, receiving the facsimile usable data and the recipient information transmitted from the sender facsimile machine through the first network, temporarily containing the facsimile usable data received in the receiving step, searching to detect the user information, which corresponds to the recipient information being received in the receiving step, identifying the location of the predetermined receiver facsimile machine based on the location information being associated with the user information which is detected in the searching step, and transmitting the facsimile usable data being received in the receiving step and temporarily contained in the containing step to the predetermined receiver facsimile machine through the second network based on the location s indicated by the location information identified in the identifying step.

According to still another aspect of the invention, there is provided a data delivery apparatus to deliver facsimile usable data transmitted from a sender facsimile machine through a first network to a predetermined receiver facsimile machine through a second network according to recipient information, which indicates an intended recipient of the facsimile usable data and is associated with the facsimile usable data. The data delivery apparatus includes a storing unit to store user information, which indicates a user of the predetermined receiver facsimile machine, to be associated with location information, which indicates a location of the predetermined receiver facsimile machine, a receiving unit to receive the facsimile usable data and the recipient information transmitted from the sender facsimile machine through the first network, a container unit to temporarily contain the facsimile usable data received by the receiving unit, a search unit to search to detect the user information, which corresponds to the recipient information being received by the receiving unit, an identifying unit to identify the location of the predetermined receiver facsimile machine based on the location information being associated with the user information which is detected by the search unit, and a transmission unit to transmit the facsimile usable data being received by the receiving unit and temporarily contained by the container unit to the predetermined receiver facsimile machine through the second network based on the location information identified in the identifying unit through the second network.

According to the above configurations, when the facsimile usable data along with the first information is transmitted from the sender-side transmitter unit to the facsimile server, the facsimile usable data is temporarily stored in the server-side data storage whilst the first information is transmitted by the sender-side transmitter unit to the administrative terminal. In the administrative terminal receiving the first information, the search unit searches through the terminal-side data storage for the second information corresponding to the first information. When the second information is detected, the terminal-side transmitter unit transmits the location information corresponding to the second information to the facsimile server. The facsimile server receiving the location information transmits the facsimile usable data to the receiver facsimile machine corresponding to the location information. Therefore, when the second information corresponding to the first information is not stored in the terminal-side data storage of the administrative terminal, the facsimile usable data is not transmitted to the receiver facsimile machine. Thus, the facsimile usable data, remaining in the facsimile transmission format and not converted into the e-mail format, can be securely transmitted to the receiver facsimile machine when the user of the receiver facsimile machine is in a condition to use the receiver facsimile machine.

### BRIEF DESCRIPTION OF THE ACCOMPANYING DRAWINGS

FIG. 1 schematically illustrates a configuration of a facsimile system according to a first embodiment of the present invention.

FIG. 2 is a block diagram to illustrate configurations of a sender facsimile machine, an administrative terminal, a facsimile server, and a receiver facsimile machine in the facsimile system according to the first embodiment of the present invention.

FIG. 3 is a flowchart to illustrate an operation of the administrative terminal in the facsimile system according to the first embodiment of the present invention.

FIG. 4 indicates a flow to register and store guest information in the administrative terminal in the facsimile system according to the first embodiment of the present invention.

FIG. 5 is a flowchart to illustrate an operation of the facsimile server in the facsimile system according to the first embodiment of the present invention.

FIG. 6 is a flowchart to illustrate an operation of the receiver facsimile machine in the facsimile system according to the first embodiment of the present invention.

FIG. 7 schematically illustrates a configuration of a facsimile system according to a second embodiment of the present invention.

FIG. 8 is a block diagram to illustrate configurations of a sender facsimile machine, an administrative terminal, a facsimile server, and a receiver facsimile machine in the facsimile system according to the second embodiment of the present invention.

FIG. 9 is a flowchart to illustrate an operation of the administrative terminal in the facsimile system according to the second embodiment of the present invention.

FIG. 10 indicates a flow to register and store guest information in the administrative terminal in the facsimile system according to the second embodiment of the present invention.

FIG. 11 is a flowchart to illustrate an operation of the facsimile server in the facsimile system according to the second embodiment of the present invention.

FIG. 12 is a flowchart to illustrate an operation of the receiver facsimile machine in the facsimile system according to the second embodiment of the present invention.

FIG. 13 schematically illustrates a varied configuration of a facsimile system according to an embodiment of the present invention.

FIG. 14 schematically illustrates a varied configuration of a facsimile system according to an embodiment of the present invention.

### DETAILED DESCRIPTION

Hereinafter, embodiments according to aspects of the present invention will be described with reference to the accompanying drawings.

### First Embodiment

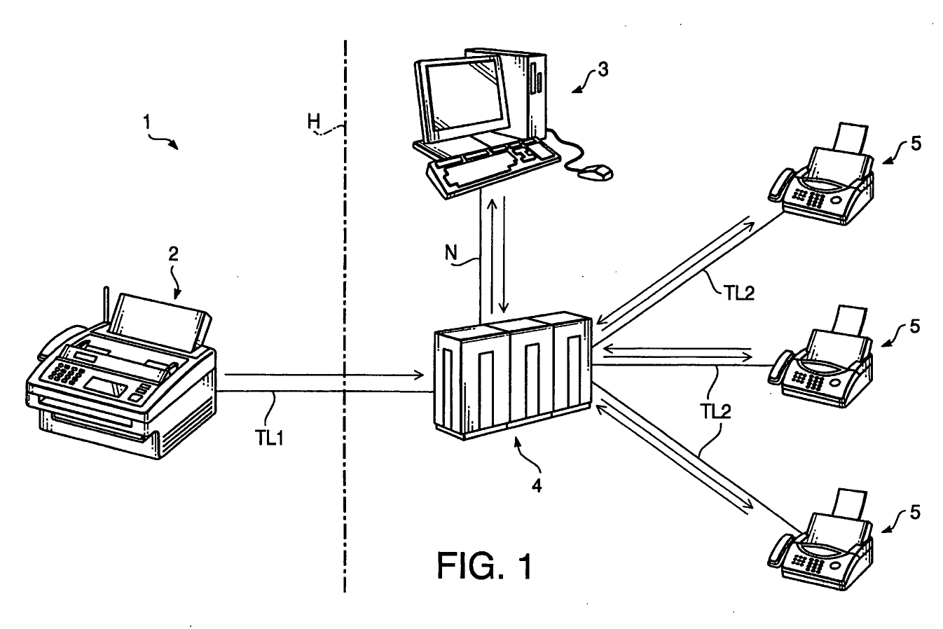

FIG. 1 schematically illustrates a configuration of the facsimile system 1 according to the first embodiment of the present invention. The facsimile system 1 includes a sender facsimile machine 2, an administrative terminal 3, a facsimile server 4, and a plurality of receiver facsimile machines 5. In the present embodiment, it is assumed that information is transmitted from the sender facsimile machine 2 to one of the receiver facsimile machines 5, each of which is equipped in a hotel room so that a guest of the hotel as an intended recipient can receive the information through the one of the receiver facsimile machines 5 in the hotel room.

The sender facsimile machine 2 is connected with the facsimile server 4 through a first telephone line TL1, which is a public telephone line, and the administrative terminal 3 is connected to the facsimile server through a network N such as a LAN (local area network). The receiver facsimile machines 5 are connected to the facsimile server 4 through second telephone lines TL2, which are internal telephone lines. The administrative terminal 3, the facsimile server 4, and the receiver facsimile machines 5 are provided within the hotel H facility. Further, the administrative terminal 3 and the facsimile server 4 are equipped at a hotel reception counter, and each of the receiver facsimile machines 5 is equipped in a guest room. Meanwhile, the sender facsimile machine 2 is provided in an external facility outside the hotel H.

Each of the sender facsimile machine 2, the administrative terminal 3, the facsimile server 4, and the receiver facsimile machines 5 in the present embodiment is provided with known hardware units (not shown in FIG. 1) such as an operation panel, a scanner unit, a printing unit, a CPU, a ROM, a RAM, a communication unit, a keyboard, a mouse.

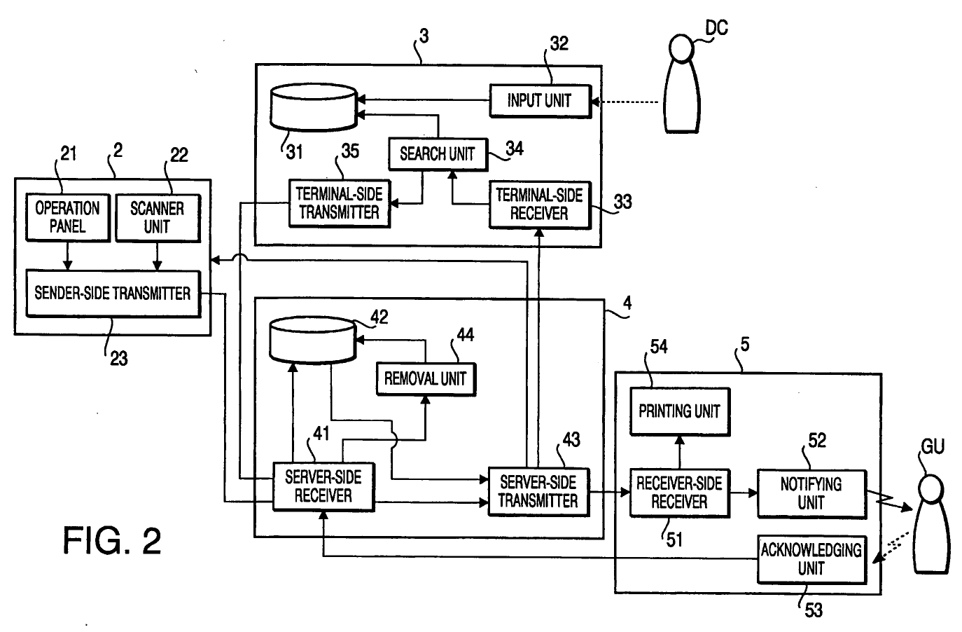

FIG. 2 is a block diagram to illustrate configurations of the sender facsimile machine 2, the administrative terminal 3, the facsimile server 4, and the receiver facsimile machine 5 in the facsimile system 1 according to the first embodiment of the present invention. As shown, the sender facsimile machine 2 includes an operation panel 21, a scanner unit 22, and a sender-side transmitter 23.

The operation panel 21 provides user interface to a user who sends the facsimile usable data (hereinafter referred to as a “sender”) so that the sender can input instructions to the sender facsimile machine 2 through the operation panel 21.

In the present embodiment, the sender enters necessary information for the facsimile transmission through the operation panel 21. The necessary information for the facsimile transmission includes a series of facsimile number to identify the receiver facsimile machine 5 and recipient information, which is information concerning an intended recipient of the facsimile usable data. The recipient information may include a name of the intended recipient, for example. The entered facsimile number and the recipient information are passed to the sender-side transmitter 23.

The scanner unit 22 reads an original image formed on a recording medium (e.g., a sheet of paper). The image read by the scanner unit 22 is generated to be the facsimile usable data and passed to the sender-side transmitter 23.

The sender-side transmitter 23 transmits the recipient information received through the operation panel 21 and the facsimile usable data received through the scanner unit 22 to the facsimile server 4, which is identified based on the facsimile number being entered through the operation panel 21.

The administrative terminal 3 includes a terminal-side data storage 31, an input unit 32, a terminal-side receiver 33, a search unit 24, and a terminal-side transmitter 35.

The terminal-side data storage 31 stores guest information, which includes information concerning guests of the hotel H (e.g., names of the guests, home addresses, and arbitrary alphanumerical characters, etc.). The guest information is stored in the terminal-side data storage 31 in association with location information, which indicates a location (e.g., a room number of the guest room) of the receiver facsimile machine 5.

The input unit 32 provides user interface to a user (e.g., a front desk clerk DC of the hotel H) so that the user can enter and delete the guest information from the terminal-side data storage 31. According to the present embodiment, the terminal-side data storage 31 stores a table including a plurality of records, each of which corresponds to a room number of a guest room. When a guest GU checks in, the front desk clerk DC enters guest information identifying the guest GU in one of the records corresponding to a guest room, in which the guest GU stays.

The terminal-side receiver 33 receives the recipient information transmitted from the sender facsimile machine 2 through the facsimile server 4. The recipient information is thereafter passed to the search unit 34.

The search unit 34 searches through the terminal-side data storage 31 to find the guest information corresponding to the recipient information, which is passed from the terminal-side receiver 33. When the guest information is found, the search unit 34 passes the location information associated with the guest information to the terminal-side transmitter 35. When no guest information corresponding to the recipient information is found, the search unit 34 passes predetermined signals indicating the search result to the terminal-side transmitter 35.

The terminal-side transmitter 35 transmits the location information associated with the guest information, which corresponds to the recipient information, to the facsimile server 4 when the guest information is found. Meanwhile, when the signals indicating the search result that no guest information corresponding to the recipient information is found are transmitted from the search unit 34, the terminal-side transmitter 35 transmits an error notice indicating the search result to the facsimile server 4.

The facsimile server 4 includes a server-side receiver 41, a server-side data storage 42, a server-side transmitter 43, and a removal unit 44.

The sever-side receiver 41 receives the facsimile usable data and the recipient information transmitted from the sender facsimile machine 2. Thereafter, the server-side receiver 41 passes the recipient information to the server-side transmitter 43 and passes the facsimile usable data to the server-side data storage 42. The server-side data storage 42 temporarily stores the facsimile usable data passed from the server-side receiver 41.

The server-side transmitter 43 transmits the recipient information passed from the server-side receiver 41 to the administrative terminal 3. The server-side transmitter 43 transmits predetermined notifying signals to one of the receiver facsimile machines 5 corresponding to the location information, which is transmitted from the administrative terminal 3. Further, the facsimile usable data stored in the server-side data storage 42 is transmitted by the server-side transmitter 43 to the one of the receiver facsimile machines 5, which corresponds to the location information, when predetermined acknowledgement from the receiver facsimile machine 5 is received in the facsimile server 4. Furthermore, the server-side transmitter 43 transmits an absence notice to the sender facsimile machine 2 when the error notice from the administrative terminal 3 is received. The absence notice may include information to indicate that the facsimile usable data will not be transmitted to the receiver facsimile machine 5.

The removal unit 44 deletes the facsimile usable data stored in the server-side data storage 42 when the error notice from the administrative terminal 3 is received in the facsimile server 4.

Each of the receiver facsimile machines 5 includes a receiver-side receiver 51, a notifying unit 52, an acknowledging unit 53, and a printing unit 54. The receiver-side receiver 51 receives the notifying signals and the facsimile usable data transmitted from the facsimile server 4. The notifying signals are passed to the notifying unit 52, and the facsimile usable data is passed to the printing unit 54.

The notifying unit 52 provides a notice to the guest GU, who is staying in the guest room equipped with the receiver facsimile machine 5, when the notifying signals are passed from the receiver-side receiver 51. The notice may be provided, for example, in a voice message and/or blinks of an indication lamp to notify the guest GU of the presence of the facsimile usable data.

The acknowledging unit 53 transmits an acknowledgement to the facsimile server 4 according to a predetermined operation by the guest GU when the guest GU enters the predetermined operation to the receiver facsimile machine 5 within a predetermined time period, which starts from the point of the notification. The predetermined operation may include, for example, pressing a button on the receiver facsimile machine 5 and entering an ID number. If no predetermined operation is given to the receiver facsimile machine 5 within the predetermined time period, the acknowledging unit 53 transmits a negative acknowledgement to the facsimile server 4.

The printing unit 54 forms images based represented by the facsimile usable data, which is passed from the receiver-side receiver 51 on a sheet of paper.

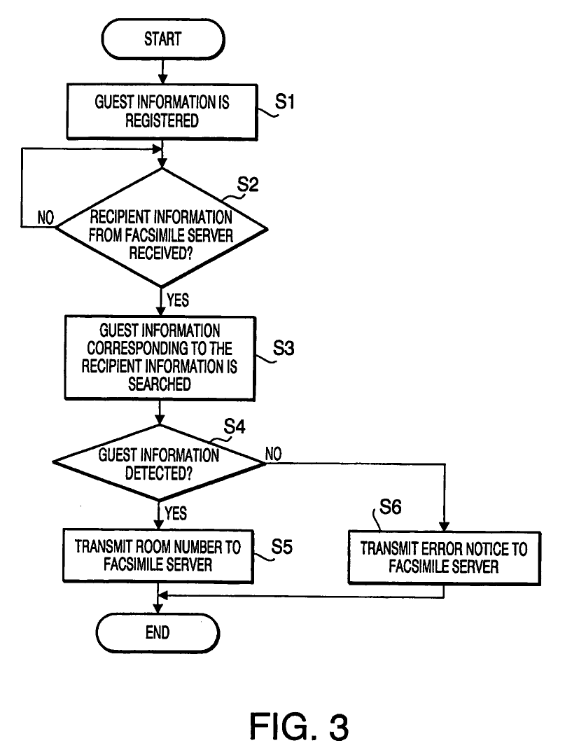

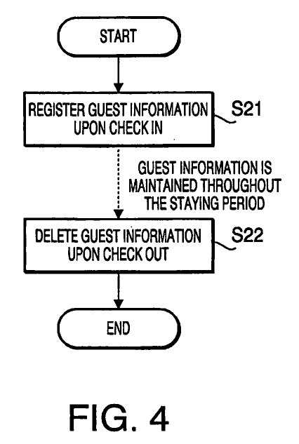

Hereinafter, operations in the administrative terminal 3, the facsimile server 4, and the receiver facsimile machine 5 in the facsimile system according to the first embodiment of the present invention will be described. In the following description, a room number of the guest room in which the guest GU stays represents the location information. Prior to the operation in the administrative terminal 3 (FIG. 3), the guest information is required to be registered and stored in the administrative terminal 3. The flow to register and store the guest information in the administrative terminal 3 is shown in FIG. 4. The registration is, for example, made by the front desk clerk DC of the hotel H by operating the input unit 32 of the administrative terminal 3 when the guest GU checks in. The guest information is stored in the terminal-side data storage 31 to be associated with the room number (i.e., the location information) of the guest room in which the guest GU stays (S21). It is noted that the guest information is deleted from the terminal-side data storage 31 by the front desk clerk DC when the guest GU checks out of the hotel H (S22). Thus, the guest information is maintained in the terminal-side data storage 31 during the period of stay. In the present embodiment, the guest information corresponds to a name of the guest GU.

An operation to be performed in the administrative terminal 3 will be described with reference to FIG. 3. FIG. 3 is a flowchart to illustrate the operation of the administrative terminal 3 in the facsimile system 1 according to the first embodiment of the present invention. First, in the administrative terminal 3, in S1, the guest information is in the terminal-side data storage 31.

Following S1, in S2, it is judged as to whether the recipient information from the facsimile server, of which detail will be described later, is received by the terminal-side receiver 33. If it is judged that no recipient information is received (S2: NO), S2 is repeated. If it is judged that the recipient information is received (S2: YES), in S3, the terminal-side data storage 31 is searched through by the search unit 34 to detect the guest information corresponding to the recipient information. In S4, it is judged as to whether the guest information corresponding to the recipient information is detected in the terminal-side data storage 31. If the guest information is detected (S4: YES), in S5, the location information (i.e., the room number) which is associated with the guest information is transmitted to the facsimile server 4 by the terminal-side transmitter 35. The operation in the administrative terminal 3 is terminated. If no guest information corresponding to the recipient information is detected (S4: NO), in S6, the error notice indicating that no guest corresponding to the intended recipient has been registered is transmitted to the facsimile server 4 by the terminal-side transmitter 35. Thereafter, the operation in the administrative terminal 3 is terminated.

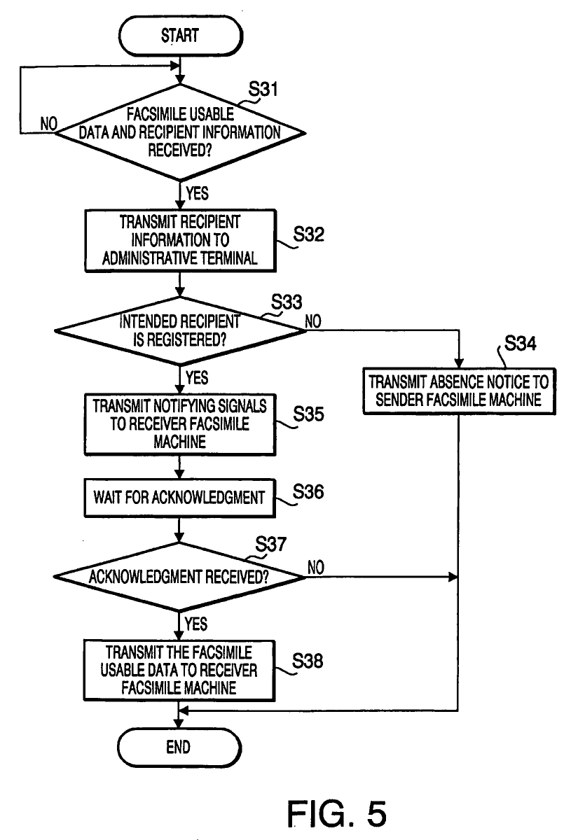

Next, an operation to be performed in the facsimile server 4 will be described with reference to FIG. 5. FIG. 5 is a flowchart to illustrate the operation of the facsimile server 4 in the facsimile system 1 according to the first embodiment of the present invention. First, in S31, it is judged as to whether the facsimile usable data with the recipient information transmitted from the sender facsimile machine 2 is received by the server-side receiver 41.

In the present embodiment, the recipient information includes information concerning the name of the intended recipient. The recipient information can be generated based on the sender's input through the operation panel 21 and/or other input unit (not shown) of the sender facsimile machine 2. For example, when the facsimile usable data from the sender facsimile machine 2 is received, the facsimile server 4 may output a predetermined voice message to require the sender to input the name of the intended recipient through the first telephone line TL1. The sender may thus enter the name of the intended recipient in a predetermined manner such as by pressing operation keys (not shown) of the sender facsimile machine 2 or by speaking out over a microphone (not shown) of the sender facsimile machine 2. When the name of the intended recipient is spoken out, the facsimile server 4 receiving the audio signals through the first telephone line TL1 can perform a sound-recognition process to generate the recipient information, which includes data representing the name of the intended recipient. Optionally, the name of the intended recipient may be obtained by a character-recognition technique. For another example, if the recipient information includes predetermined numerical characters (e.g., date of birth) to identify the guest GU, the facsimile server 4 may require the sender to input the numerical characters through the dial keys (not shown) of the sender facsimile machine 2. The entered numerical characters are generated to be the recipient information. It should be noted that, however, the methods to generate the recipient information is not limited to those described above.

In S31, if it is judged that no facsimile usable data with recipient information is received (S31: NO), S31 is repeated. If it is judged that the facsimile usable data with the recipient information is received (S31: YES), in S32, the recipient information is transmitted to the administrative terminal 3 by the server-side transmitter 43. In S33, it is judged as to whether the intended recipient is registered in the administrative terminal 3. Specifically, the judgment is made based on the response from the administrative terminal 3 (i.e., one of the room number and the error notice).

In S33, if it is judged that no intended recipient is registered (i.e., when the error notice is received) (S33: NO), in S34, the absence notice is transmitted to the sender facsimile machine 2 by the server-side transmitter 43. Further, the facsimile usable data stored in the server-side data storage 42 is deleted. The operation is terminated thereafter. In S33, if it is judged that the intended recipient is registered (i.e., when the room number is received) (S33: YES), in S35, the notifying signals are transmitted to the receiver facsimile machine 5 of the guest room corresponding to the room number.

Following S35, in S36, the facsimile server 4 waits for the acknowledgment to be transmitted from the receiver facsimile machine 5 for the predetermined time period. In S37, it is judged as to whether the acknowledgment is received by the server-side receiver 41. If it is judged that an acknowledgment is received (S37: YES), in S38, the server-side transmitter 43 transmits the facsimile usable data to the receiver facsimile machine 5 which transmitted the acknowledgment. The operation is terminated thereafter. In S37, if it is judged that a negative acknowledgment is received (S37: NO), the operation is terminated.

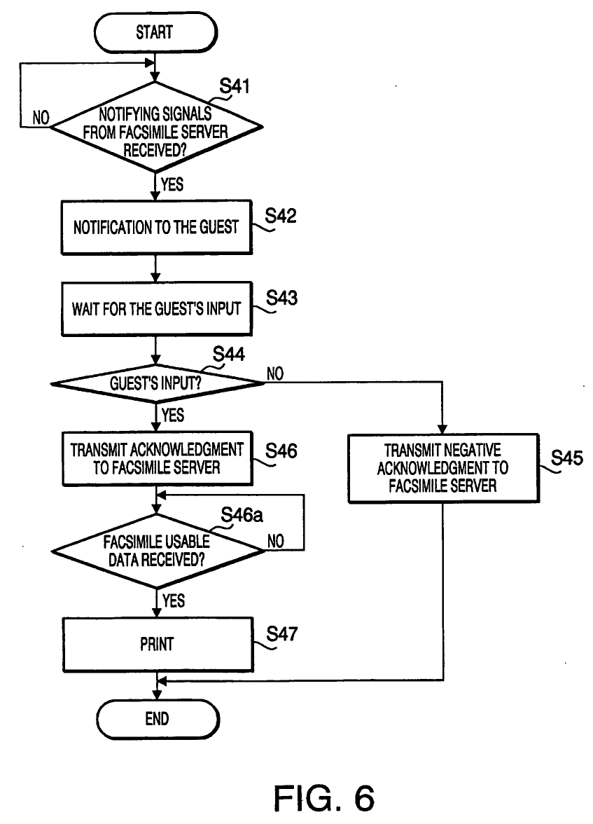

Hereinafter, an operation to be performed in the receiver facsimile machine 5 will be described with reference to FIG. 6. FIG. 6 is a flowchart to illustrate the operation of the receiver facsimile machine 5 in the facsimile system 1 according to the first embodiment of the present invention. First, in the receiver facsimile machine 5, in S41, it is judged as to whether the notifying signals from the server-side transmitter 43 are received by the receiver-side receiver 51. If it is judged that no notifying signals are received (S41: NO), S41 is repeated. If it is judged that the notifying signals are received (S41: YES), in S42, a notice is provided to the guest GU by the notifying unit 52. Thereafter, in S43, the receiver facsimile machine 5 waits for the predetermined time period for the guest GU to enter the predetermined operation to the receiver facsimile machine 5. In S44, it is judged as to whether the guest CU enters the predetermined operation. If it is judged that no operation is entered (S44: NO), in S45, the acknowledging unit 53 transmits the negative acknowledgment to the facsimile server 4. If it is judged that the predetermined operation is entered (S44: YES), in S46, the acknowledging unit 53 transmits the acknowledgment to the facsimile server 4. In S46a, it is judged as to whether the facsimile usable data, transmitted from the facsimile server 4 in response to the acknowledgment, is received by the receiver-side receiver 51. If no facsimile usable data is received (S46a: NO), S46a is repeated. If the facsimile usable data is received (S46a: YES), in S47, the printing unit 54 prints the image represented by the facsimile usable data on the sheet of paper for the guest GU to view.

With the above configuration of the facsimile system 1, the facsimile usable data is not transmitted to the receiver facsimile machine 5 from the facsimile server 4 unless the guest information corresponding to the recipient information, which is specified by the sender, is detected in the terminal-side data storage 31. Therefore, the facsimile usable data inputted in the sender facsimile machine 2 is not converted into the e-mail format but can be securely transmitted to the intended recipient.

Further, if no affirmative response to the notice from the facsimile server 4 is returned to the facsimile server 4 by the guest GU, who is a substantially authenticated user of the receiver facsimile machine 5, the facsimile usable data is not transmitted to the receiver facsimile machine 5. Therefore, confidentiality of the information in the facsimile usable data can be maintained.

If no guest information corresponding to the recipient information is detected by the search unit 34, the sender is notified of the absence of the intended user by the absence notice, which is transmitted from the terminal-side transmitter 35 to the sender facsimile machine 2. Therefore, the sender can be aware of the failure of the transmission of the facsimile usable data. Furthermore, if no guest information is detected, the facsimile usable data transmitted from the sender facsimile machine 2 and stored in the server-side data storage 42 is deleted. Therefore, the facsimile usable data, which may otherwise occupy the server-side data storage 42, can prevent from being unnecessarily stored in the server-side data storage 42.

### Second Embodiment

Hereinafter, a second embodiment according to another aspect of the present invention will be described. In the present embodiment, a configuration in a facsimile system 1′ similar to that in the facsimile system 1 in the previous embodiment is referred to by the identical reference numeral, and description of that will be omitted.

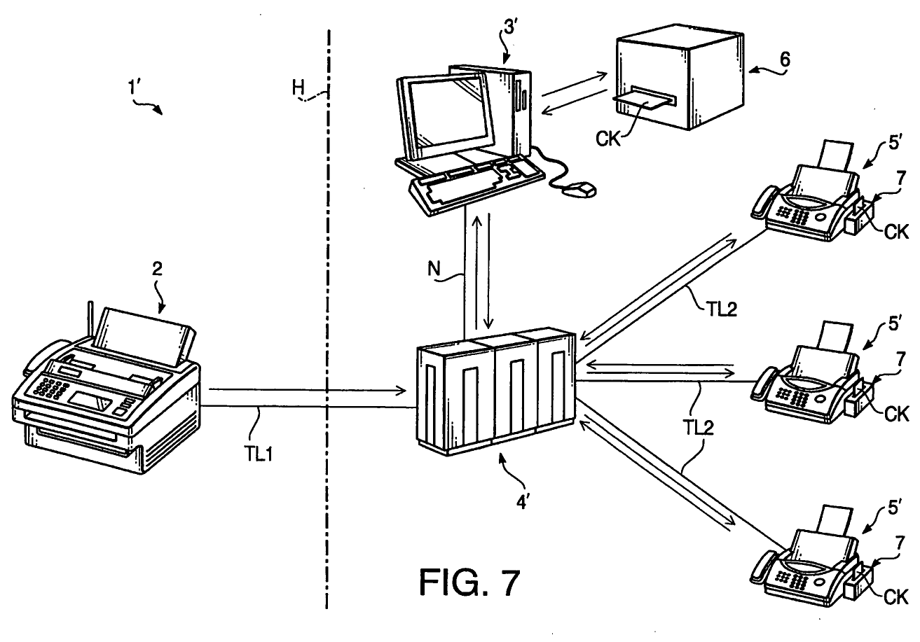

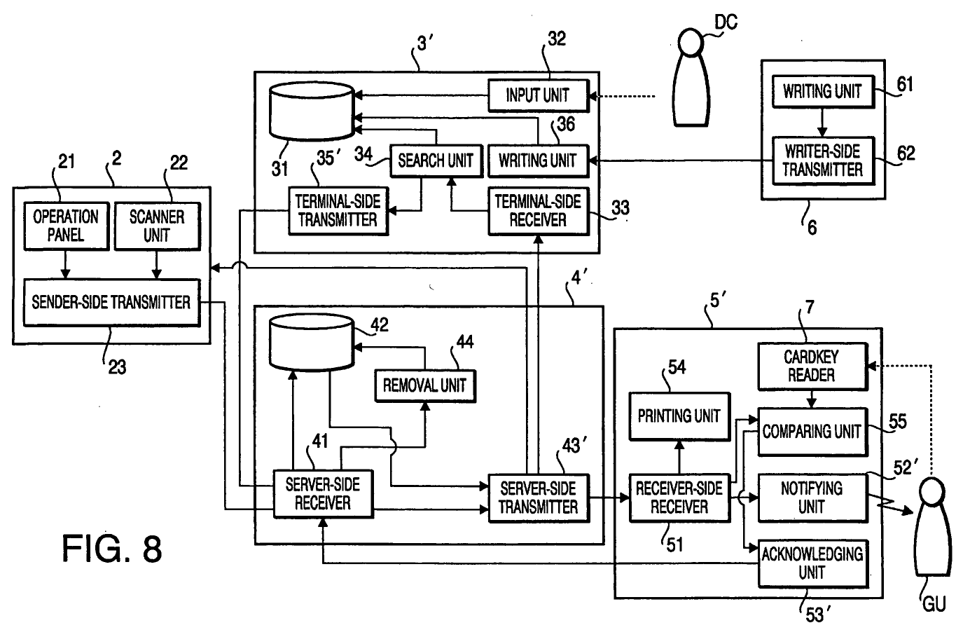

FIG. 7 schematically illustrates a configuration of the facsimile system 1′ according to the second embodiment of the present invention. FIG. 8 is a block diagram to illustrate configurations of the sender facsimile machine 2, an administrative terminal 3′, a facsimile server 4′, and receiver facsimile machines 5′ in the facsimile system 1′ according to the second embodiment of the present invention. The facsimile system 1′ includes, in addition to the configuration in the facsimile system 1 of the previous embodiment, a cardkey writer 6 and cardkey readers 7, each of which is connected with the receiver facsimile machine 5′. The receiver facsimile machines 5′, the administrative terminal 3′, and the facsimile server 4′ have similar configuration to the receiver facsimile machines 5, the administrative terminal 3, and the facsimile server 4 in the previous embodiment respectively, but differences in detail will be described later.

The cardkey writer 6 is a device to write specific information to identify a holder of a cardkey CK in the cardkey CK as a recording medium and is connected with the administrative terminal 3′. As show in FIG. 8, the cardkey writer 6 includes a writing unit 61 and a writer-side transmitter 62. The writing unit 61 records predetermined identifying information of the holder in the cardkey CK. When information is recorded in the cardkey CK, the identical information (duplicated information) is passed to the writer-side transmitter 62. The identifying information may be entered in the cardkey writer 6 through the input unit 32 of the administrative terminal 3′ or may be entered through an input unit (not shown) equipped to the cardkey writer 6. The writer-side transmitter 62 transmits the duplicated information, passed from the writing unit 61, to the administrative terminal 3′.

The cardkey reader 7 reads the identifying information recorded in the cardkey CK and passes the identifying information to a comparing unit 55 of the receiver facsimile machine 5′.

The administrative terminal 3′ includes a writing unit 36 and a terminal-side transmitter 35′. The writing unit 36 stores the duplicated information transmitted from the writer-side transmitter 62 in the terminal-side data storage 31. The duplicated information stored in the terminal-side data storage is associated with the location information concerning the guest room, in which the receiver facsimile machine 5′ is equipped. When the guest information corresponding to the recipient information is detected by the search unit 34, the terminal-side transmitter 35′ transmits the location information corresponding to the guest information and the duplicated information associated with the location information to the facsimile server 4′.

The facsimile server 4′ includes a server-side transmitter 43. When the location information and the duplicated information from the administrative terminal 3′ are received by the server-side receiver 41, the server-side transmitter 43′ transmits the duplicated information to the receiver facsimile machine 5′, which is identified by the location information.

The receiver facsimile machine 5′ includes the comparing unit 55 and a notifying unit 52′. The comparing unit 55 compares the duplicated information transmitted from the facsimile server 4′ and received by the receiver-side receiver 51 with the identifying information recorded in the cardkey CK and read by the cardkey reader 7. When the duplicated information coincides with the identifying information, the comparing unit 55 passes an authentication acknowledgment, indicating that the holder of the cardkey CK is an authorized guest GU of the guest room, to the acknowledging unit 53′. When the duplicated information does not coincide with the identifying information, the comparing unit 55 passes a negative authentication acknowledgment, indicating the holder of the cardkey CK is not authorized, to the acknowledging unit 53′. The notifying unit 52′ provides indication to prompt the guest GU to have the contents of the cardkey CK read by the cardkey reader 7. The acknowledging unit 53, transmits an acknowledgment to the facsimile server 4′ when the authentication acknowledgment is passed from the comparing unit 55. The acknowledging unit 53′ transmits a negative acknowledgment to the facsimile server 4′ when the negative authentication acknowledgment is passed from the comparing unit 55.

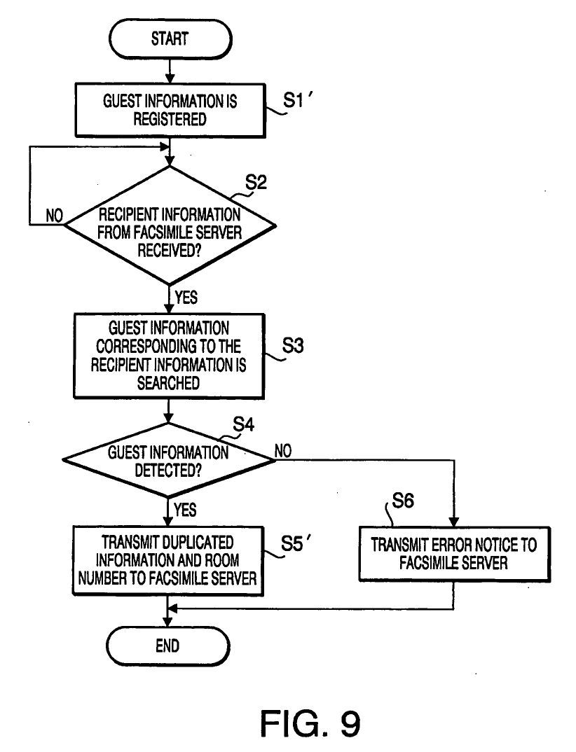

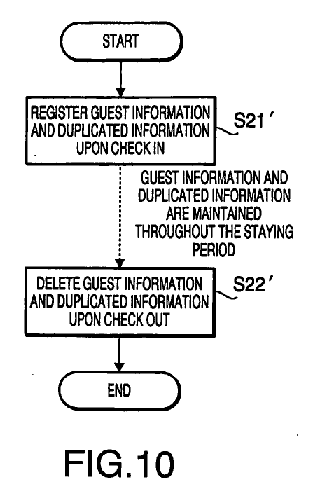

Hereinafter, operations in the administrative terminal 3′, and the receiver facsimile machine 5′ in the facsimile system according to the second embodiment of the present invention will be described. The operation in the facsimile server 4′ is substantially equivalent to the operation in the facsimile server 4 as shown FIG. 5. Therefore, description of the operation will be omitted. In the second embodiment, similarly to the first embodiment, the guest information is required to be registered and stored in the administrative terminal 3 prior to the operation in the administrative terminal 3 (FIG. 9). The guest information is stored in the terminal-side data storage 31 to be associated with the room number (i.e., the location information) of the guest room in which the guest GU stays. In addition, the identifying information is recorded in the cardkey CK, which is a key to the guest room, by the front desk clerk DC, and the duplicated information is transmitted from the writer-side transmitter 62 to be received in the administrative terminal 3′. The flow to register and store the guest information in association with the duplicated information in the administrative terminal 3′ is shown in FIG. 10. The duplicated information received in the administrative terminal 3′ is stored in the terminal-side data storage 31 in association with the guest information and the location information (S21′). It is noted that the guest information, the duplicated information, and the identifying information are deleted from the terminal-side data storage 31 by the front desk clerk DC when the guest GU checks out of the hotel H (S22′). Thus, the guest information, the duplicated information, and the identifying information are maintained in the terminal-side data storage 31 during the period of stay. In the present embodiment, similarly to the previous embodiment, the guest information corresponds to a name of the guest GU.

An operation to be performed in the administrative terminal 3′ will be described with reference to FIG. 9. FIG. 9 is a flowchart to illustrate the operation of the administrative terminal 3′ in the facsimile system 1′ according to the second embodiment of the present invention.

First, in S1′, in the administrative terminal 3′, the guest information is in the terminal-side data storage 31.

The steps S2, S3, and S4 are substantially equivalent to those in the operation of the administrative terminal 3 in the first embodiment. In S5′, the terminal-side transmitter 35, transmits the duplicated information to the facsimile server 4′ in addition to the room number.

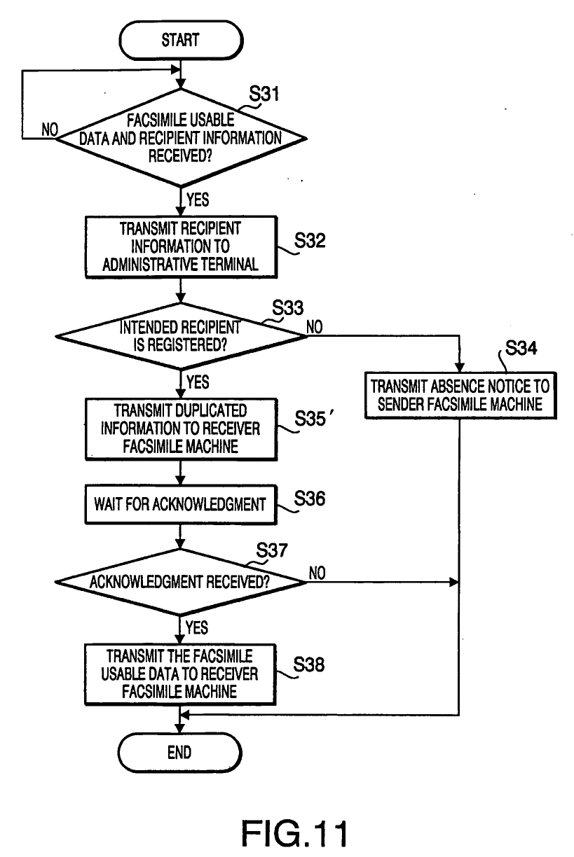

Next, an operation to be performed in the facsimile server 4′ will be described with reference to FIG. 11. FIG. 11 is a flowchart to illustrate the operation of the facsimile server 4′ in the facsimile system 1′ according to the second embodiment of the present invention. In this operation, S31, S32, S33, S34, S36, S37, and S38 are performed similarly to those in the operation in the administrative terminal 3 in the first embodiment. It is noted, however, that S35 is replaced with S35′. In S35′, the server-side transmitter 43′ of the facsimile server 4′ transmits the duplicated information to the receiver facsimile machine 5′.

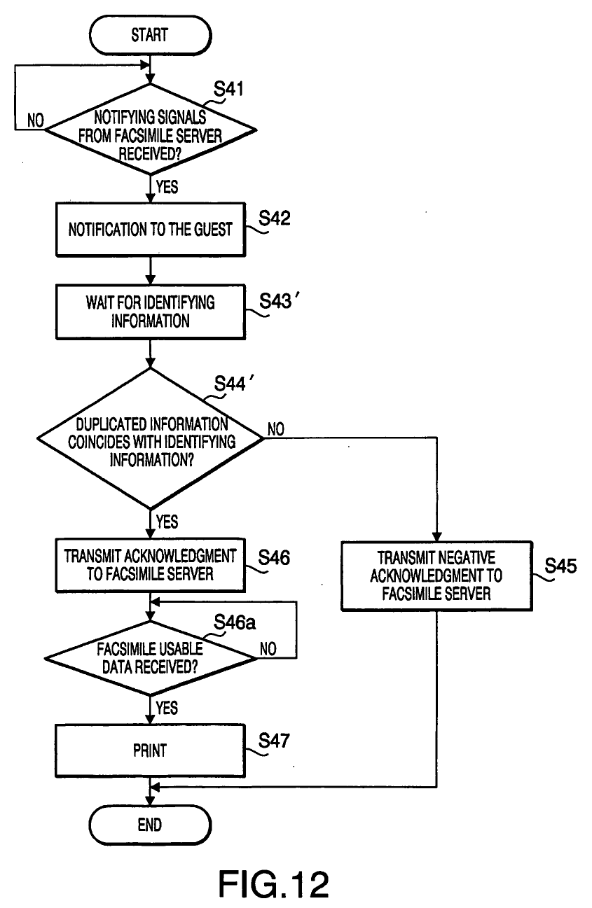

Next, an operation to be performed in the receiver facsimile machine 5′ will be described with reference to FIG. 12. FIG. 12 is a flowchart to illustrate the operation of the receiver facsimile machine 5′ in the facsimile system 1′ according to the second embodiment of the present invention. In this operation, S41, S42, S45, S46, S46a, and S47 are performed similarly to those in the operation in the receiver facsimile machine 5 in the first embodiment. It is noted, however, that S43 and S44 are replaced with S43′ and S44′ respectively. In S43′, the receiver facsimile machine 5′ waits for the predetermined time period for the guest GU to have the contents of the cardkey CK read by the cardkey reader 7. After the identifying information registered in the cardkey CK is obtained, in S44′, it is judged as to whether the duplicated information coincides with the identifying information and the holder of the cardkey CK is the authorized guest GU (i.e., the intended recipient) of the guest room. If it is judged that the duplicated information does not coincide with the identifying information (S44′: NO), in S45, the acknowledging unit 53′ transmits the negative acknowledgment to the facsimile server 4′. If it is judged that the duplicated information coincides with the identifying information (S44′: YES), in S46, in the acknowledging unit 53′ transmits the acknowledgment to the facsimile server 4′.

With the configuration described above, the facsimile usable data is not transmitted to the receiver facsimile machine 5 unless the identifying information recorded in the cardkey CK, which is held by the guest GU, coincides with the duplicated information in the terminal-side data storage 31′ of the administrative terminal 3′. Therefore, the facsimile usable data inputted in the sender facsimile machine 2 can be securely transmitted to the intended recipient.

Although examples of carrying out the invention have been described, those skilled in the art will appreciate that there are numerous variations and permutations of the facsimile system that falls within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims.

For example, in S34 in FIG. 5 and FIG. 11 in the above embodiments, the facsimile usable data stored in the server-side data storages 42, 42′ of the facsimile servers 4, 4′ is deleted. However, in this step, it can be judged as to whether a predetermined time period elapsed. If it is judged that the predetermined time period has not been elapsed, the process can be returned to S32. If it is judged that the predetermined time period has elapsed, the process can be terminated. In this configuration, the facsimile usable data with the recipient information is not removed from but maintained in the server-side data storage 42. It is noted that there may be a case that the sender attempts to transmit the facsimile usable data before the intended recipient checks in the hotel H. In the above configuration, however, if the intended recipient checks in within the predetermined time period, the guest information in the administrative terminal 3 corresponding to the recipient information in the facsimile server 4 can be detected so that the facsimile usable data can be transmitted to the receiver facsimile machine 5.

For another example, a location in which the administrative terminal 3, the facsimile server 4, and the receiver facsimile machines 5 are equipped is not limited to a hotel facility. The administrative terminal 3, the facsimile server 4, and the receiver facsimile machines 5 can be located in a corporate building, and the identifying information can be recorded in employee ID cards with RFID (radio frequency identification) tags.

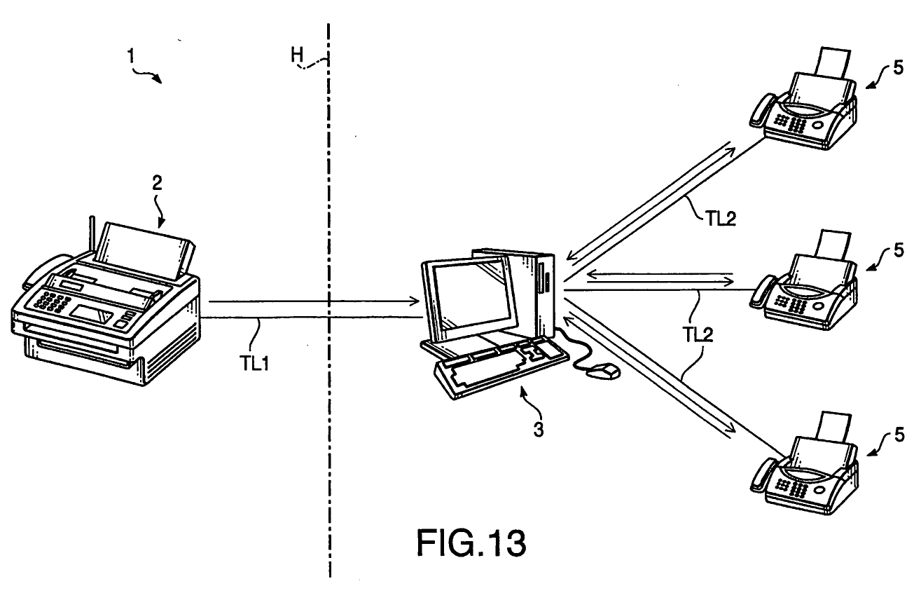

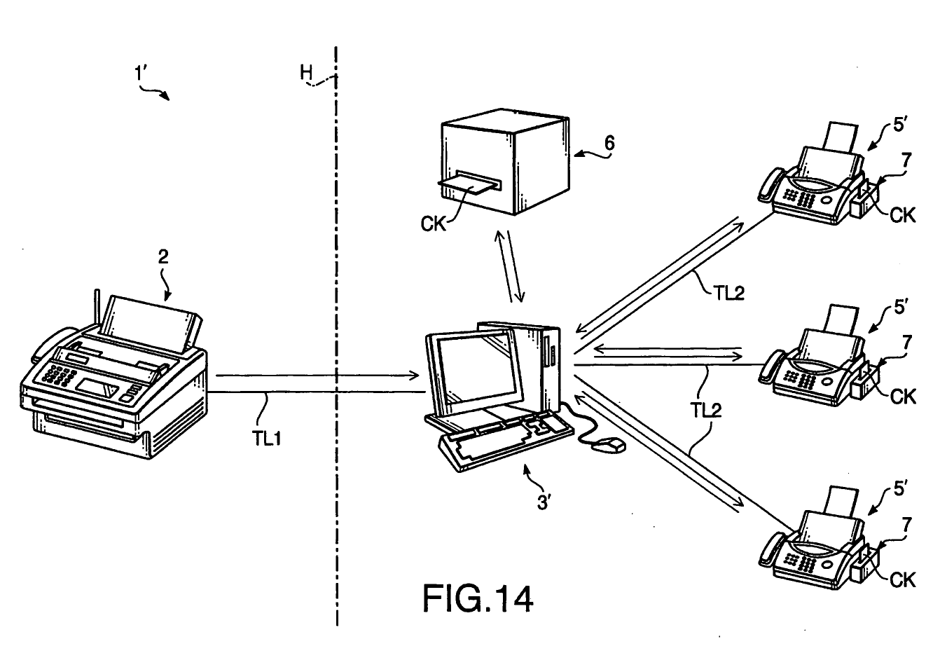

For another example, the administrative terminals 3, 3′ and the facsimile servers 4, 4′ are respectively integrally configured, as shown in FIGS. 13 and 14.

What is claimed is:

1. A facsimile system, comprising:
a facsimile server;
an administrative terminal, which is connected with the facsimile server;
a sender facsimile machine, which is connected with the facsimile server through a first network; and
a plurality of receiver facsimile machines, which are connected with the facsimile server through a second network,
wherein the sender facsimile machine includes a sender-side transmitter unit, which transmits facsimile usable data and first information indicating an intended recipient of the facsimile usable data to the facsimile server;
wherein the administrative terminal includes;
a terminal-side data storage, which stores second information, indicating a user of one of the receiver facsimile machines, and location information, indicating a location of the one of the receiver facsimile machines, the second information and the location information being associated with each other in the terminal-side data storage;
an input unit, which is operated to store and remove the second information in and from the terminal-side data storage;
a terminal-side receiver unit to receive the first information transmitted from the sender-side transmitter via the facsimile server;
a search unit to search the terminal-side data storage to detect the second information, which corresponds to the first information being received by the terminal-side receiver unit; and
a terminal-side transmitter unit to transmit the location information, which is associated with the second information, to the facsimile server when the second information is detected by the search unit; and
wherein the facsimile server includes:
a server-side receiver unit to receive the facsimile usable data and the first information transmitted from the sender-side transmitter unit;
a server-side data storage to store the facsimile usable data transmitted from the sender-side transmitter unit for a predetermined time period;
a server-side transmitter unit to transmit the first information, transmitted from the sender-side transmitter unit, to the administrative terminal and the facsimile usable data to the one of the receiver facsimile machines, which is indicated by the location information, when the location information transmitted from the terminal-side transmitter unit is received by the server-side receiver unit.

2. The facsimile system according to claim 1,
wherein the server-side transmitter unit transmits notifying signals for notifying the user of presence of the facsimile usable data in the server-side data storage to the one of the receiver facsimile machines according to the location information transmitted from the terminal-side transmitter unit;
wherein each of the receiver facsimile machines includes:
a receiver-side receiver unit to receive the notifying signals transmitted from the server-side transmitter unit;
a notifying unit to provide a notice for notifying the user of the presence of the facsimile usable data in the server-side data storage of the facsimile server; and
an acknowledgment transmitter unit to transmit acknowledging signals to the facsimile server according to an operation given by the user to the one of the receiver facsimile machines, and
wherein the server-side transmitter unit transmits the facsimile usable data to the one of the receiver facsimile machines, of which location is indicated by the location information, when the acknowledging signals from the acknowledgment transmitter unit of the facsimile server are received by the server-side receiver unit.

3. The facsimile system according to claim 2,
wherein the administrative terminal is connected with an identifying information writable device, which writes identifying information to identify the user of the one of the receiver facsimile machines in a recording medium;
wherein the identifying information writable device includes a device-side transmitter unit, which transmits duplicated information of the identifying information to the administrative terminal when the identifying information writable device writes the identifying information in the recording medium;
wherein the administrative terminal includes a writing unit, which stores the duplicated information in the terminal-side data storage to be in association with the location information;
wherein the terminal-side transmitter unit transmits the duplicated information and the location information being in association with the duplicated information to the facsimile server;
wherein the server-side transmitter unit transmits the duplicated information to the one of the receiver facsimile machines, which is indicated by the location information being transmitted from the terminal-side transmitter unit;
wherein each of the receiver facsimile machines includes:
an identifying information readable unit to read the identifying information written in the recording medium; and
a comparing unit to compare the duplicated information transmitted from the server-side transmitter unit with the identifying information read by the identifying information readable unit and judge as to whether the duplicated information coincides with the identifying information;
wherein the notifying unit provides a notice to the user to prompt the user to let the identifying information readable unit read contents written in the recording medium; and
wherein the acknowledgment transmitter unit transmits the acknowledging signals to the facsimile server when the comparing unit judges that the duplicated information coincides with the identifying information.

4. The facsimile system according to claim 1,
wherein the terminal-side transmitter unit transmits error signals to the facsimile server when the search unit searches through the terminal-side data storage but finds absence of the second information corresponding to the first information;
wherein the server-side transmitter unit transmits an absence notice, indicating that the facsimile usable data is in an incapable condition to be transmitted, to the sender facsimile machine when the error signals from the terminal-side transmitter unit are received by the server-side receiver unit of the facsimile server.

5. The facsimile system according to claim 1,
wherein the terminal-side transmitter unit transmits error signals to the facsimile server when the search unit searches through the terminal-side data storage but finds absence of the second information corresponding to the first information; and
wherein the facsimile server includes a removal unit to remove the facsimile usable data from the server-side data storage of the facsimile server when the error signals from the terminal-side transmitter unit are received by the server-side receiver unit of the facsimile server.

6. A method to deliver facsimile usable data transmitted from a sender facsimile machine to a predetermined receiver facsimile machine through a first network and a second network according to recipient information, the recipient information indicating an intended recipient of the facsimile usable data and being associated with the facsimile usable data, comprising steps of:
storing user information, which indicates a user of the predetermined receiver facsimile machine, to be associated with location information, which indicates a location of the predetermined receiver facsimile machine;
receiving the facsimile usable data and the recipient information transmitted from the sender facsimile machine through the first network;
temporarily containing the facsimile usable data received in the receiving step;
searching to detect the user information, which corresponds to the recipient information being received in the receiving step;
identifying the location of the predetermined facsimile machine based on the location information being associated with the user information which is detected in the searching step; and
transmitting the facsimile usable data being received in the receiving step and temporarily contained in the containing step to the predetermined receiver facsimile machine through the second network based on the location identified in the identifying step.

7. The method according to claim 6,
wherein the transmitting step includes transmitting an absence notice, which indicates that the facsimile usable data being received is in an incapable of condition to be transmitted to the predetermined receiver facsimile machine, to the sender facsimile machine, when absence of the user information, which corresponds to the recipient information, is found in the searching step.

8. The method according to claim 6, further comprising a step of:
deleting the facsimile usable data being temporarily contained when absence of the user information, which corresponds to the recipient information, is found in the searching step.

9. A data delivery apparatus to deliver facsimile usable data transmitted from a sender facsimile machine through a first network to a predetermined receiver facsimile machine through a second network according to recipient information, the recipient information indicating an intended recipient of the facsimile usable data and being associated with the facsimile usable data, comprising:
a storing unit to store user information, which indicates a user of the predetermined receiver facsimile machine, to be associated with location information, which indicates a location of the predetermined receiver facsimile machine;
a receiving unit to receive the facsimile usable data and the recipient information transmitted from the sender facsimile machine through the first network;
a container unit to temporarily contain the facsimile usable data received by the receiving unit;
a search unit to search to detect the user information, which corresponds to the recipient information being received by the receiving unit;
an identifying unit to identify the location of the predetermined receiver facsimile machine based on the location information being associated with the user information which is detected by the search unit; and
a transmission unit to transmit the facsimile usable data being received by the receiving unit and temporarily contained by the container unit to the predetermined receiver facsimile machine through the second network based on the location information identified by the identifying unit.

10. The data delivery apparatus according to claim 9,
wherein the transmission unit transmits an absence notice, indicating that the facsimile usable data being received is in an incapable of condition to be transmitted to the predetermined receiver facsimile machine, to the sender facsimile machine, when absence of the user information, which corresponds to the recipient information, is found by the search unit.

11. The data delivery apparatus according to claim 9, further comprising:
a deleting unit to delete the facsimile usable data being temporarily contained from the container unit when absence of the user information, which corresponds to the recipient information, is found by the search unit.
